(19) United States
(12) Patent Application Publication
(10) Pub. No.: US 2017/0239127 A1
(43) Pub. Date: Aug. 24, 2017

(54) BACKBONE RETRACTION APPARATUS

(71) Applicant: Jin Han PARK, Daegu (KR)

(72) Inventor: Jin Han PARK, Daegu (KR)

(21) Appl. No.: 15/357,307

(22) Filed: Nov. 21, 2016

(30) Foreign Application Priority Data
Feb. 19, 2016 (KR) 10-2016-0019650

(51) Int. Cl. A61H 1/02; A63B 21/00; A63B 23/02

(52) U.S. Cl. CPC A61H 1/0292; A63B 23/0238; A63B 21/4039; A63B 2023/006

(57) ABSTRACT

Disclosed is a backbone retraction apparatus which includes a support member supporting a hip of a user, a center member coupled to the support member by a hinge structure, a backrest member inserted into the center member, a neck support member inserted into the backrest member, moving means comprising a wire having a first side fixed to the center member and a second side fixed to the neck support member and a first latching protrusion protruded from the backrest member and adapted to have the wire hung on the first latching protrusion, the second side of the wire being fixed under the first latching protrusion, and length adjustment means adapted to be connected to the support member and the backrest member.

### CROSS-REFERENCE TO RELATED APPLICATION

Pursuant to 35 U.S.C. §119(a), this application claims the benefit of earlier filing date and right of priority to Korean Patent Application No. 10-2016-0019650, filed on Feb. 19, 2016, the contents of which are incorporated by reference herein in their entirety.

### BACKGROUND

Field of the Invention

The present invention relates to a backbone retraction apparatus which enables a user to stretch his or her backbone by pulling the backbone in the state in which the user has sit or lied down on the backbone retraction apparatus and, more particularly, to a backbone retraction apparatus configured to safely relax the backbone by a simple action of a user.

Discussion of the Related Art

As disclosed in Prior Art Document, in general, a backbone retraction apparatus may be divided into a backbone retraction apparatus operating in the state in which a user lie down on the apparatus and a backbone retraction apparatus operating in the state in which a user sits on the apparatus. Technologies for relaxing the backbone by a user's force or relaxing the backbone by a motor have been disclosed.

Furthermore, in general, conventional technologies include configurations for relaxing the backbone of a waist portion. There has been disclosed a stopping-down apparatus configured to move the head of a user to the position lower than the waist in order to relax the backbone from the waist to the neck.

### PRIOR ART DOCUMENT

### Patent Document

(Patent Document 0001) Patent Document 1. Korean Patent Application Publication No. 10-2015-0057717

(Patent Document 0002) Patent Document 2. Korean Patent Application Publication No. 1 0-201 2-001 4652

(Patent Document 0003) Patent Document 3. Korean Patent Application No. 10-2014-0144565

### SUMMARY

An object of the present invention is to provide a backbone retraction apparatus capable of pulling and relaxing the backbone by only an action of simply pushing the back.

Another object of the present invention is to provide a backbone retraction apparatus capable of suppressing excessive relaxation attributable to traction.

In an aspect of the present invention, a backbone retraction apparatus includes a support member 100 supporting the hip of a user, a center member 200 coupled to the support member 100 by a hinge structure 300, a backrest member 400 inserted into the center member 200, a neck support member 500 inserted into the backrest member 400, moving means 600 connected to the center member 200, the backrest member 400, and the neck support member 500, and length adjustment means 700 configured to have the support member 100 and the backrest member 400 connected thereto.

Furthermore, the moving means 600 includes a wire 610 having one side fixed to the center member 200, a first latching protrusion 620 protruded and formed in the backrest member 400 and having the wire 610 hung thereon, a first latching protrusion 620 and a second latching protrusion 630 formed in the neck support member 500, formed under the first latching protrusion 620, and configured to have the other side of the wire 610 fixed thereto or protruded and formed on both sides of the wire 610 and the backrest member 400 having both ends fixed to both sides of the center member 200, respectively, so that the wire 610 is hung on the first and the second latching protrusions, and a third latching protrusion 640 formed in the neck support member 500, formed under the first latching protrusion 620 and the second latching protrusion 630, and configured to have the middle of the wire 610 hung thereon.

The length adjustment means 700 is a shock absorber and further includes an adjustment valve 710 for controlling pressure of the shock absorber.

Furthermore, the wire 610 fixed to the center member 200 further includes elastic means 800. The neck support member 500 further includes the elastic means 800.

### BRIEF DESCRIPTION OF THE DRAWINGS

FIG. 1 is a diagram showing the state in which a backbone retraction apparatus according to an embodiment of the present invention is used.

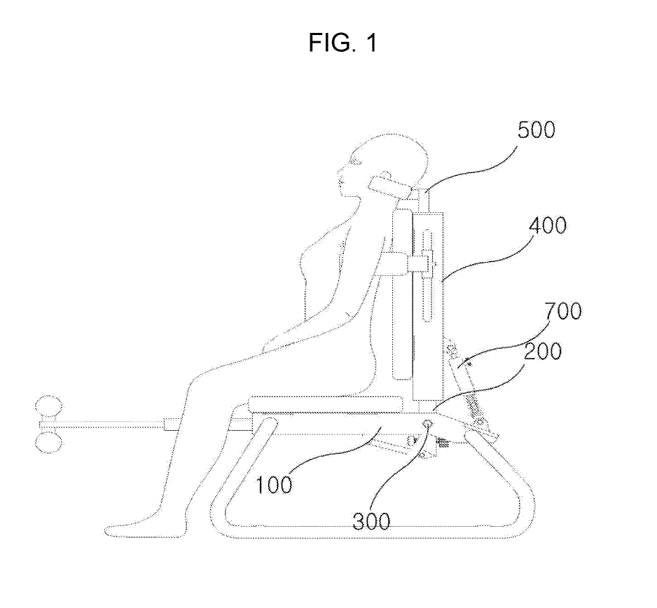

FIG. 2 is a partially cut view of the back of the backbone retraction apparatus according to an embodiment of the present invention.

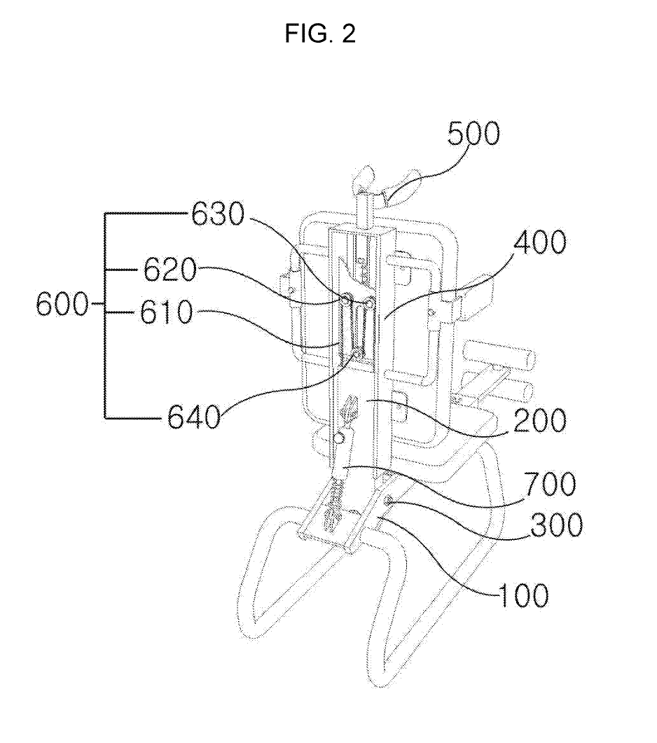

FIG. 3 is a partially cut view showing the state in which the center member of the backbone retraction apparatus according to an embodiment of the present invention has been rotated.

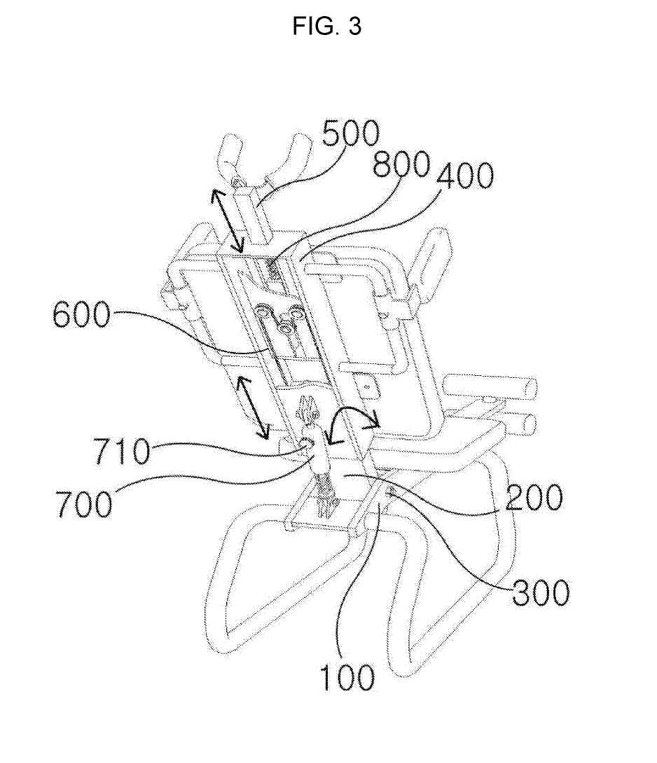

FIG. 4 is a partially cut view showing the moving means of the backbone retraction apparatus according to an embodiment of the present invention.

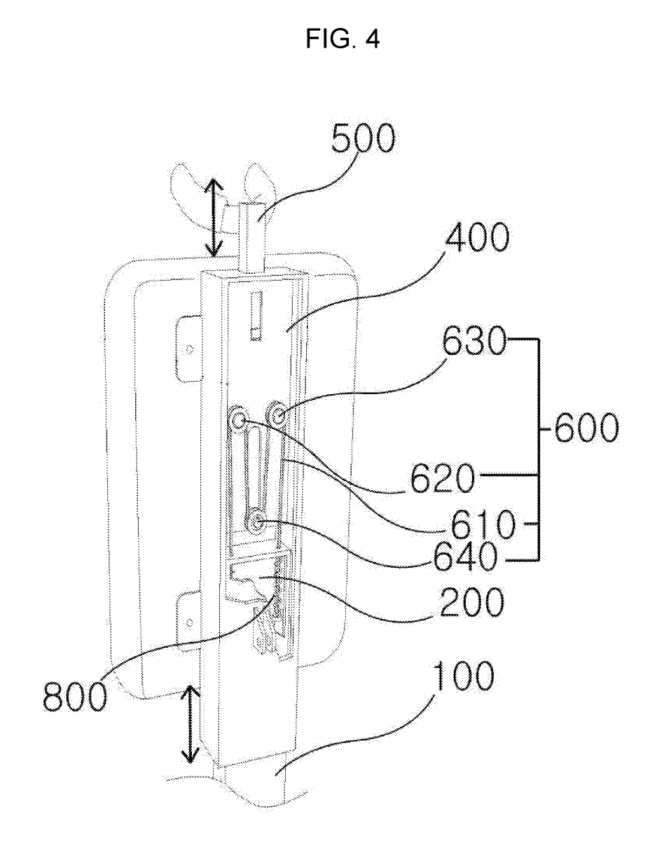

### DETAILED DESCRIPTION

The present invention relates to a backbone retraction apparatus configured to safely relax the backbone by a simple action of a user. The backbone retraction apparatus basically includes a support member 100 configured to support the hip of a user, a center member 200 coupled to the horizontal member 100 by a hinge structure 300, a backrest member 400 configured to freely move in the length direction of the center member 200, a neck support member 500 configured to freely move in the length direction of the backrest member 400, moving means 600 configured to move the neck support member 500 in response to a movement of the backrest member 400, and length adjustment means 700.

Hereinafter, a schematic configuration of the backbone retraction apparatus according to an embodiment of the present invention is described in detail with reference to the accompanying drawings.

First, the support member 100 according to an embodiment of the present invention is formed in a size capable of supporting the hip of a user. In this case, a “ [symbol] ”-shaped groove of a size so that the center member 200 can be inserted into the “ [symbol] ”-shaped groove is formed on one side of the support member 100. A hole symmetrical to a protruded member is formed in the “ [symbol] ” shape.

The support member 100 configured as described above is configured so that a user can stably sit on the support member 100.

Second, the center member 200 is formed to have a size so that the center member 200 can be inserted into the groove of the “ [symbol] ” shape of the support member 100. In this case, another hole corresponding to the hole formed in the support member 100 is formed in the center member 200.

The center member 200 configured as described above is coupled to the support member 100 by the hinge structure 300 in such a way as to freely turn.

A wire 610 fixed to the center member 200 further includes elastic means 800. One side of the elastic means 800 is configured to come into contact with the center member 200, and the other side thereof is configured to come into contact with the backrest member 300. The wire 610 may be configured to reduce a sudden change or a force that exceeds the relaxation threshold of a user.

Third, the hinge structure 300 refers to a known structure capable of freely turning. In an embodiment of the present invention, a single bolt is inserted into the holes formed in the support member 100 and the center member 200 and fixed by a nut.

Fourth, the backrest member 400 is formed in a pipe shape so that the center member 200 can be inserted into the inside of the backrest member 400. A backrest unit of a size capable of supporting the back of a user is configured on one side of the backrest member 400.

The backrest member 400 configured as described above is configured to have the center member 200 inserted therein and to freely move along the center member 200.

If the elastic means 800 is further configured in the middle of the backrest member 400, a latching plate may be protruded so that the elastic means 800 is engaged with the latching plate.

Fifth, the neck support member 500 is inserted into the backrest member 400, but is partially protruded. A face support unit capable of supporting the lower side of a face is configured on one side of the protruded part.

The neck support member 500 configured as described above is configured to be inserted into the backrest member 400 and to freely move along the backrest member 400.

The neck support member 500 is configured to be divided into a portion to which the wire 610 is connected and a portion supporting the neck. The elastic means 800 is further included between the two portions in the state in which a known spring has been extended. The neck support member 500 may be configured to reduce a sudden change or a force that exceeds the relaxation threshold of a user.

Sixth, the moving means 600 includes the wire 610 and a first latching protrusion 620 protruded from one surface of the backrest member 400.

In the moving means 600 configured as described above, an end on one side of the wire 610 is fixed to the back of the center member 200 by welding, engaged with the first latching protrusion 620, and then fixed to the bottom of the neck support member 500 by welding so that the wire 610 has a “z,22 ” shape, but one side of the “ [symbol] ” shape is short.

In the moving means 600 completed as described above, if the backrest member 400 exits from the center member 200, the interval between the center member 200 and the first latching protrusion 620 is widened. The length of the wire 610 connected from the first latching protrusion 620 to the neck support member 500 is reduced by the interval widened as described above, so the neck support member 500 can easily exit from the backrest member 400.

The moving means 600 includes the wire 610 configured to have both ends fixed to both sides of the center member 200, respectively, the first latching protrusion 620 and a second latching protrusion 630 protruded and formed on both sides of the backrest member 400 and configured to have the wire 610 hung thereon, and a third latching protrusion 640 formed in the neck support member 500, formed under the first latching protrusion 620 and the second latching protrusion 630, and configured to have the middle of the wire 610 hung thereon so that the wire 610 may have an “M” shape.

Furthermore, the wire 610 may be made of an elastic material so that it can reduce a sudden change or a force that exceeds the relaxation threshold of a user.

Seventh, the length adjustment means 700 is formed in a pole shape of a specific length. One side of the length adjustment means 700 is coupled to an end on one side of the support member 100, which is protruded in the direction in which the center member 200 is turned, by the hinge structure 300. The other side of the length adjustment means 700 is coupled to the backrest member 400 by the hinge structure 300. Accordingly, the length adjustment means 700 is completed in an inclined shape.

The length adjustment means 700 completed as described above is configured to be pushed by its fixed length when the backrest member 400 is turned in the state horizontal to the support member 100.

The length adjustment means 700 is a known shock absorber and further includes an adjustment valve 710 for adjusting pressure of the shock absorber. The length adjustment means 700 may be configured to reduce a sudden change or a force that exceeds the relaxation threshold of a user.

More specifically, the shock absorber is configured to have its length returned to its original position depending on the manipulation state of the adjustment valve 710 after the backrest member 400 is turned in the state horizontal to the support member 100 and thus the length thereof is increased.

An operation relation between the elements of backbone retraction apparatus is described below in connection with embodiments.

### First Embodiment

In the first embodiment, the center member 200 is inserted to be partially protruded from an end on one side of the support member 100 and coupled thereby by the hinge structure 300. The center member 200 is inserted into the backrest member 400 and coupled thereto.

Furthermore, the neck support member 500 is inserted into the backrest member 400. An end on one side of the wire 610 of the moving means 600 is fixed to the back of the center member 200 by welding, engaged with the first latching protrusion 620, and then fixed to the bottom of the neck support member 500 by welding so that the wire 610 has a “ [symbol] ” shape, but one side of the “ [symbol] ” shape is short.

Finally, one side of the length adjustment means 700 is coupled to one side of the end of the support member 100 protruded in the direction in which the center member 200 is turned by the hinge structure 300. The other side of the length adjustment means 700 is coupled to the backrest member 400 by the hinge structure 300. Accordingly, the first embodiment of the present invention is completed.

In the first embodiment completed as described above, when a user leans his or her back against the backrest member 300 in the state in which the user has sit on the support member 100 and bends his or her back backward in the state in which the head is brought into contact with the neck support member 500, the center member 200 inserted into the backrest member 300 and the neck support member 500 are pushed backward and rotated by the hinge structure 300 of the center member 200 and support member 100 through the length adjustment means 700.

At this time, the length adjustment means 700 having a fixed length is gradually changed into the state horizontal to the support member 100. When the length adjustment means 700 is changed into the horizontal state in the state in which it has been inclined, the backrest member 400 configured to freely move along the center member 200 is pushed upward, so the backbone of the user is relaxed.

More specifically, if the backrest member 400 is pushed upward, the backrest member 400 is pushed upward from the center member 200. Accordingly, the distance between the backrest member 400 and the center member 200 is increased.

At this time, the length of the wire 610 of the moving means 600 connected to the backrest member 400 and the center member 200 is increased, whereas the length of the wire 610 of the moving means 600 connected to the backrest member 400 and the neck support member 500 is reduced.

That is, when the backrest member 400 is pushed by the length adjustment means 700, the neck support member 500 is pulled by the moving means 600 and moved upward, thereby relaxing the cervical vertebrae.

As described above, in an embodiment of the present invention, when the center member 200 is turned from the support member 100, the neck support member 500, together with the backrest member 400, is lengthened by the moving means 600.

Accordingly, there is an advantage in that the backbone of a user can be relaxed by only an action of simply bending back.

### Second Embodiment

The configuration of the first embodiment is applied to the second embodiment of the present invention without change, but a spring, that is, the elastic means 800, is inserted into the wire 610 fixed to the center member 200. Furthermore, one side of the elastic means 800 comes into contact with the center member 200, and the other side thereof comes into contact with the latching plate formed in the backrest member 300.

Furthermore, the neck support member 500 is divided into the portion to which the wire 610 is connected and the portion supporting the neck. The elastic means 800 is disposed between the two portions and connects the two portions. The wire 610 of the moving means 600 is made of an elastic material.

Furthermore, the length adjustment means 700 is a known shock absorber and further includes the adjustment valve 710 for adjusting pressure of the shock absorber, thereby completing the second embodiment of the present invention.

In the second embodiment completed as described above, as in the first embodiment, when the backbone is relaxed, but a user suddenly bends his or her back backward, pressure of the length adjustment means 700, that is, a shock absorber, prevents the backrest member 200 from suddenly moving. Accordingly, a safety accident which may occur due to the sudden relaxation of the backbone can be prevented. Furthermore, a condition in which the shock absorber operates can be easily controlled by the adjustment valve 710 of the shock absorber.

Furthermore, a sudden movement of the backrest member 200 can be reduced by the elastic means 800 disposed in the wire 610 fixed to the backrest member 200.

Furthermore, if the backrest member 200 and the neck support member 500 are lengthened as much as possible, a maximum relaxation distance of the cervical vertebrae may be exceeded depending on the physical conditions of a user. If the physical features of a user is small, but the neck support member 500 is moved to a maximum relaxation distance or more of the cervical vertebrae, only the bottom of the neck support member 500 fixed to the wire 610 is moved upward by the elastic means 800 including the extended spring of the neck support member 500.

That is, although the center member 200 continues to turn, the upper position of the neck support member 500 can be fixed until the elastic means 800 is contracted as much as possible.

Furthermore, the wire 610 of the moving means 600 is made of an elastic material. Although the center member 200 continues to turn, the position of the neck support member 500 and the backrest member 200 can be fixed until the wire 610 is extended as much as possible.

The length of the shock absorber returns to its original position depending on the manipulation state of the adjustment valve 710 after the backrest member 400 is turned in the state horizontal to the support member 100 and thus the length of the shock absorber is increased. Accordingly, there is an advantage in that the backbone that has been relaxed can return to its original position because the length of the shock absorber return to its original position and thus the backrest member 400 slowly descends.

As described above, the present invention has an advantage in that it can prevent a safety accident which may occur due to the excessive relaxation of the backbone or cervical vertebrae because the backrest member 400 and the neck support member 500 are prevented from being excessively lengthened.

In an embodiment of the present invention, if the center member 200 is turned from the support member 100, the backrest member 400 is pushed upward by the length adjustment means 700 and the neck support member 500, together with the backrest member 400, is lengthened by the moving means 600. Accordingly, there is an advantage in that the backbone of a user can be relaxed by only an action of simply bending backward.

Furthermore, the wire 610 made of an elastic material and the elastic means 800 configured in the center member 200 and the neck support member 500 prevent the backrest member 400 and the neck support member 500 from being excessively lengthened. Accordingly, there is an advantage in that a safety accident which may occur due to the excessive relaxation of the backbone or cervical vertebrae can be prevented.

Furthermore, the length adjustment means 700 is configured using a shock absorber. Accordingly, there is an advantage in that a safety accident which may occur due to the relaxation of the backbone can be prevented because a sudden turn of the center member 200 is suppressed.

What is claimed is:

1. A backbone retraction apparatus, comprising:
a support member 100 supporting a hip of a user;
a center member 200 coupled to the support member 100 by a hinge structure 300;
a backrest member 400 inserted into the center member 200;
a neck support member 500 inserted into the backrest member 400;
moving means 600 comprising a wire 610 having a first side fixed to the center member 200 and a second side fixed to the neck support member 500 and a first latching protrusion 620 protruded from the backrest member 400 and adapted to have the wire 610 hung on the first latching protrusion 620, the second side of the wire 610 being fixed under the first latching protrusion 620; and
length adjustment means 700 adapted to be connected to the support member 100 and the backrest member 400.

2. The backbone retraction apparatus of claim 1, wherein the moving means 600 comprises:
the wire 610 configured to have both ends fixed to both sides of the center member 200, respectively,
the first latching protrusion 620 and a second latching protrusion 630 protruded and formed on both sides of the backrest member 400 and configured to have the wire 610 hung on the first and the second latching protrusions, and
a third latching protrusion 640 formed in the neck support member 500, formed under the first latching protrusion 620 and the second latching protrusion 630, and configured to have a middle of the wire 610 hung on the third latching protrusion 640.

3. The backbone retraction apparatus of claim 1, wherein the wire 610 is made of an elastic material.

4. The backbone retraction apparatus of claim 3, wherein the length adjustment means 700 comprises a shock absorber.

5. The backbone retraction apparatus of claim 4, wherein the length adjustment means 700 further comprises an adjustment valve 710 for adjusting pressure of the shock absorber.

6. The backbone retraction apparatus of claim 1, wherein:
elastic means 800 is further included in the wire 610 fixed to the center member 200, and
a first side of the elastic means 800 comes into contact with the center member 200 and a second side of the elastic means 800 comes into contact with the wire 610 hung on the backrest member 400.

7. The backbone retraction apparatus of claim 1, wherein:
the neck support member 500 is divided into a portion to which the wire 610 is connected and a portion supporting the neck, and
elastic means 800 is further configured between the two portions.
